(19) United States
(12) Patent Application Publication
(10) Pub. No.: US 2011/0106784 A1
(43) Pub. Date: May 5, 2011

(54) SYSTEM AND METHOD FOR PUBLISHING MEDIA OBJECTS

(76) Inventors: Merijn Camiel Terheggen, Alameda, CA (US); Eldert Jasper van Wijngaarden, Groningen (NL); Mathijs Homminga, Groningen (NL); Jenny Zepf, Groningen (NL); Robert Hofstra, Groningen (NL); Nico van Ek, Steenwijk (NL)

(21) Appl. No.: 12/716,243

(22) Filed: Mar. 2, 2010

Related U.S. Application Data
(63) Continuation-in-part of application No. 12/098,251, filed on Apr. 4, 2008.
Application No. 12/098,251 is a continuation-in-part of application No. 12/098,388, filed on Apr. 4, 2008.
(60) Provisional application No. 61/156,831, filed on Mar. 2, 2009.

(51) Int. Cl. G06F 17/30

(52) U.S. Cl. 707/706; 707/E17.108

(57) ABSTRACT

According to one or more embodiments, media objects are published on publisher resources. In one embodiment, a web resource is provided on a network having a first domain or location. Responsive to a terminal accessing the first location to render the web resource, a search parameter is signaled to a search engine that operates at a second location or domain on the network. A search response is received that includes media object data. The media object data identifies one or more galleries of media objects. The media object data may be used include at least a portion of a gallery of media objects as part of the web resource that is rendered for the terminal.

### RELATED APPLICATIONS

This application claims benefit of priority to provisional U.S. Patent Application No. 61/156,831, entitled “System and Method for Publishing Media Objects,” filed on Mar. 2, 2009; the aforementioned priority application being hereby incorporated by reference in its entirety.

This application is a continuation-in-part of U.S. Utility application Ser. No. 12/098,251, entitled “System and Method for Identifying Galleries of Media Objects on a Network”; and of U.S. Utility application Ser. No. 12/098,388 entitled “System and Method for Presenting Gallery Renditions That Are Identified From A Network,” both filed on 4 Apr. 2008. Both of the aforementioned applications are hereby incorporated by reference in their entirety.

### TECHNICAL FIELD

The disclosed embodiments relate to a system and method for publishing galleries of media objects.

### BACKGROUND

With the Internet, numerous search engines and searching techniques have been developed. Search engines such as provided by GOOGLE INC. and YAHOO INC. enable searching for text, images, or videos. There is a trend to increase the kinds of data that users are capable of searching.

Concurrently with the development of search engines, web-based content is increasingly more visual. Individuals have blogs managed at service sights such as FLICKR. Businesses use images to promote products. And the search engines enable image searching using a variety of techniques.

### BRIEF DESCRIPTION OF THE DRAWINGS

FIG. 1 illustrates a system for utilizing media object galleries at a publisher site, under an embodiment.

FIG. 2 illustrates logic that may be implemented with programmatic element, under an embodiment.

FIG. 3 illustrates an implementation in which a publisher resource is presented as a web page that is augmented with media object data, supplied from a search engine service, according to an embodiment.

FIG. 4 illustrates a method for providing media objects that supplement a web pages existing content, using a search service, under an embodiment.

FIG. 5 illustrates a method for assigning and distributing revenue to media objects that are then made available to supplement existing content on a web page, according to an embodiment.

### DETAILED DESCRIPTION

According to one or more embodiments, media objects are published on publisher resources. In one embodiment, a web resource is provided on a network having a first domain or location. Responsive to a terminal accessing the first location to render the web resource, a search parameter is signaled to a search engine that operates at a second location or domain on the network. A search response is received that includes media object data. The media object data identifies one or more galleries of media objects. The media object data may be used to include at least a portion of a gallery of media objects as part of the web resource that is rendered for the terminal.

A “media object” includes visual content items, including images (JPEG, PNG, BMP or similar formats), animated graphics (GIF file), video clips or segments, or the combination of visual content items and other forms of data (e.g. picture/video and text/or audio). Media objects may also extend to streaming media, such as FLASH or Flex media where the user may receive a rendition of a “live” or occurring event. Other media examples include Java Applet, Prism, Silverlight media, or other forms of scripts or programmable objects. Thus, a media object may include streams, or binary sets of programmatic instructions and data (e.g. like a Flash movie, which is a combination of scripts and content that is rendered by the script/programmatic elements).

A “gallery” refers to a collection of media objects that individually reside at a source location and are presented at their respective source locations in a manner that reflects a common characteristic. The common characteristic may reflect editorial considerations, such as unity of content, theme, authorship, or source of creation. In some (but not all) cases, the media objects that comprise the gallery are generally presented together. In the context of a network such as the Internet, the media objects of a gallery may be distributed on the same page (or presentation or resource), or on different pages (or presentations or resources) that are related to one another as parent-child, siblings, parent-grand-child, or otherwise part of an internal network system that is linked directly or indirectly to other pages that contain other media objects of the same gallery, where the pages that contain and separate the media objects have a common point of access and share the theme or editorial considerations of the gallery. In some other cases, for example, sub pages or sub presentations can provide some elements or constituents of a gallery.

A “network resource” includes data that is renderable or otherwise available to a browser or other network navigation component at a network location. Examples include a page or web-based presentation or portions thereof or a media object as described above.

A “gallery rendition” or “gallery presentation” includes content that is derived from one or more galleries, and can typically include content from multiple galleries and/or commercial content. Such presentations or renditions may be provided with interactive functionality and navigational optional, including functionality to programmatically monitor user interaction with the galleries. Gallery renditions and presentations may also extend to, or include, sponsored content.

Collections of media objects may be aggregated from network resources available over a network. An embodiment provides that a network resource is accessed at each of a plurality of network locations. The network resource is analyzed at each network location to determine whether the network resource includes, or provides access to, any or all media objects in a set of multiple media objects that collectively satisfy one or more editorial criteria for being deemed a gallery, as presented at the network location or network locations where the multiple media objects are provided. The information about the set of media objects may be stored.

One or more embodiments described herein may be implemented using modules. A module may include a program, a subroutine, a portion of a program, a software component or a hardware component capable of performing a stated task or function. As used herein, a module can exist on a hardware component such as a server independently of other modules, or a module can exist with other modules on the same server or client terminal, or within the same program.

Furthermore, one or more embodiments described herein may be implemented through the use of instructions that are executable by one or more processors. These instructions may be carried on a computer-readable medium. Machines shown in figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, Flash memory (such as carried on many cell phones and personal digital assistants (PDAs)), and magnetic, optical and other memory. Computers, terminals, network enabled devices (e.g. mobile devices such as cell phones and PDA's) are all examples of machines and devices that utilize processors, memory, and instructions stored on computer-readable mediums.

System Description

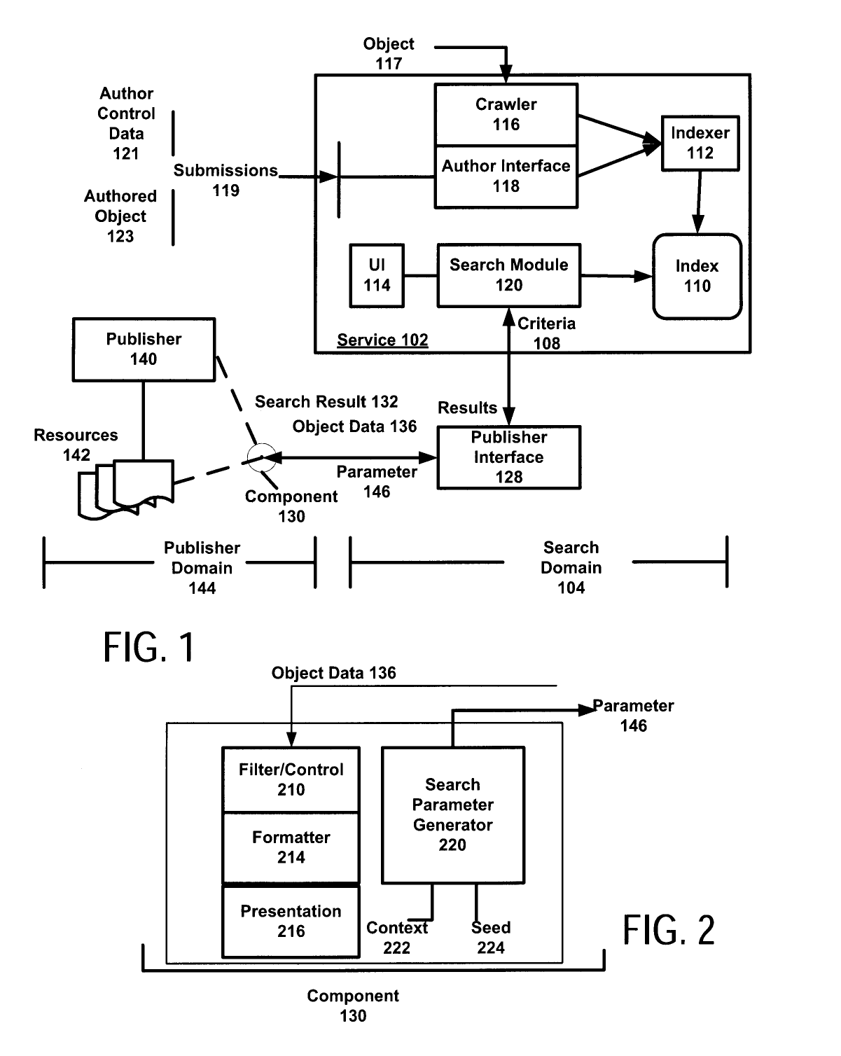

FIG. 1 illustrates a system for utilizing media object galleries at a publisher site, under an embodiment. A system includes a search-service 102 that enables search operations to be performed on an index 110 in order to identify galleries of media objects. The index 110 may be built using an indexer 112 that retrieves or identifies galleries of media objects from sources that include (i) network sites, including web pages, and (ii) submissions by authors of media object galleries. A system such as described with FIG. 1 can be implemented using a combination of processors, memory resources and network resources. In an embodiment, the system of FIG. 1 is implemented on a server, or combination of servers, in order to provide the service 102. In some implementations, various servers combine to provide the service 102. User interaction with service 102 may be through browsers or web-enabled components. The interaction with other domains or publishers, as described below, may be through a network such as the Internet.

In an embodiment, the indexer 112 interfaces with a web crawler 116 that crawls the World Wide Web to programmatically identify galleries of media objects. Such processes/components for programmatically identifying media objects over a network is disclosed by co-pending U.S. patent application Ser. Nos. 12/098,251 and 12/098,388. The crawler 116 retrieves objects 117 (e.g. images, media files) and analyzes the objects 117 to determine whether a given set of objects appearing on one or more web pages or resources are a gallery. If a gallery is determined to be present, some or all of the objects of the gallery are retrieved and stored, with identifying information (and optionally the objects or version thereof) being stored in the index 110. As an alternative or addition, the network locations of the objects in the gallery are identified and stored in the indexer 110 along with other information for use in presenting the identified objects as a gallery.

To receive author submissions, the indexer 112 includes an author interface 118 that receives author submissions 119. The author submissions 119 include media objects that are authored or under control of a user. Users that present submissions to the search service 102 may be of a class that is deemed to be an author. In some cases, the author may include author controls 121 with objects 123 that are included in the submissions. The controls 121 specify conditions and criteria by which the media objects 123 of the submissions 119 may be displayed or re-displayed. For example, the author 121 can specify that one or more of the author's media objects are displayed only once, or only once on a given publisher site or domain. The author 121 can also exclude some domains, or publishers by class or genre. Various other types of author controls may also be implemented.

Objects from crawler 116 and/or author interface 118 are processed by indexer 112 and stored in index 110. This information may include (i) identification information of each object, (ii) identification information of one or more galleries that the object is deemed to belong to, (iii) network location information (if different than the identification information) for enabling a programmatic element to retrieve an object, (iv) characteristic information to enable programmatic association of the object and/or gallery with other criteria (such as search terms), and/or (v) copies or versions of the individual objects.

Service 102 makes the index 110 available for use to different classes of users. In an embodiment, service 102 is provided at a domain 104 on the World Wide Web. One or more components may interface with index 110 in order to enable selection or search of galleries of media objects from the index. In one embodiment, index 110 supports user-specified searches for galleries. In particular, an interface 114 is provided with a search module 120 to enable a user to specify terms, expressions or conditions for selecting or searching for media objects. As an addition or alternative, the search module 120 also supports programmatically triggered searches or selections for media objects and galleries. Each search may correspond to the search module 120 performing a selection or search using, for example, BOOLEAN expressions, selection terms, keywords, geolocation information, category specification (e.g. specified by user, determined from classification of publisher site), demographic information about a user or about an audience of a publisher or other user profiling information. In one embodiment, the search module 120 implements a comparison of criterion (e.g. text keyword or visual component of media object) against contents of index 110 to identify media objects and/or galleries that satisfy the criteria of the search. For example, search criteria in the form of text or visual component of a media object is satisfied when a match of the search criteria is found in the index 110 in association with the media objects. Relevancy algorithms may be used to determine the best match. Search intelligence may be used to determine similarity between words or media objects or objects and scenes depicted within images or other image specific information, such as matching the search criteria to index information that is a synonym for the same word.

According to one or more embodiments, the service 102 is extended and made available for programmatic use to publishers on other domains. In one embodiment, a publisher interface 128 of service 102 distributes, or enables distribution of an integrated publisher component 130. According to an embodiment, the programmatic component 130 interfaces or integrates with the publisher 140 or its resources 142 (e.g. a web page) to generate a search parameter 146. The search parameter 146 may be created with purpose of enhancing the content appearing on the publisher resource 142 by presenting a gallery of media objects. The search parameter 146 may thus be generated in order to specify programmatically created criteria 108 to the search component 120 on behalf of publisher 140, or for publisher resources 140. Among other examples, the search parameters enable identification or selection of media objects provided as galleries. The search parameter 146 can be generated from content provided on the resources, metadata identified from the publisher or its resources, other external information (geographic information pertaining to the publisher; demographic information of the publisher audience), and/or the IP address or network location of the publisher.

In an embodiment, the programmatic component 130 is implemented as a script (e.g. ‘widget’) in the web page or resource of the publisher. The publisher interface 128 generates the script for inclusion by a publisher administrator in the publisher's web pages. The publisher administrator may manually interact with the publisher interface 128 to have the script or its identifier generated. The publisher administrator can then copy and paste the script (or the script identifier) onto the source of its web page. In an embodiment, the publisher resources 142 correspond to web pages that include text, images, and/or media objects selected or created by the publisher 140 or its user. The programmatic component 130 (e.g. script) may be included in a web page to trigger the component, or the publisher 140, from interacting and communicating the search parameter 146 to the interface 128. In turn, the publisher interface 128 communicates search criteria 108 that corresponds to or is based on the search parameter, to the search component 120, which performs the search on behalf of the publisher.

As a script, the manner in which the programmatic component 130 is triggered to communicate with the search service 102 may vary. The script may be embedded into the source of the web page and triggered upon events such as described above (e.g. page rendering, detection of user activity, duration that a page is open, viewer of the page looking at advertisement). Upon being triggered, the script causes the submission of the parameter 146 to the search service 102. The publisher resources 142 and provided by publisher 140, on a publisher domain 142, separate from the search domain 104. The search parameter 146 corresponds to text entries or terms that are (i) selected by the publisher, or (ii) programmatically determined. The search parameter 146 may correspond to a term, or set of terms (or data for identifying such) that have relevance to a theme or category of interest of content appearing at the publisher's resources.

In an embodiment the search parameter 146 is selected by the publisher 140 as a set, that is rotated or randomly selected for use in response to events such as page views. In still another embodiment, the search parameter 146 is programmatically determined from various factors, including, for example, content appearing on the publisher resource 142. The content may be analyzed for text data, image data, or metadata in order to determine its general theme or topic. Some types of content may be prioritized over other kinds of topics. For example, advertisement content may be a low weight in identifying relevance, while comments from users is provided a high weight. Other information for determining the search parameter 146 may include information determined from the publisher domain (e.g. URL term), demographic or profile information known about the publisher 140 or the publisher's domain 144.

Upon submitting parameter 146, the search component 120 performs a search using index 110. A search result 132 is returned to the programmatic component 130. The search result 132 may correspond to objects or galleries, in form of identification or provided by actual images and/or content. According to an embodiment, the search result 132 is processed by the programmatic component 130. The processing 130 may be in form of (i) ranking or selecting objects and/or galleries identified in the search result, and/or (ii) excluding galleries/objects returned in the search result.

Galleries of media objects that are processed may be selected for display on the publisher resources for various uses. In one embodiment, galleries (as identified and processed) may be identified and published on a web page corresponding to the publisher resource 142 in response to a trigger event or condition. The trigger event or condition may correspond to instances (i) in which the web page is rendered, (ii) an occurrence of a user entering a search term or selecting a specific link, and (iii) passage of time in which a page is actively viewed or rendered, or various other factors. Upon a triggering event, the galleries of the media objects are rendered or displayed. The objects may be retrieved from the actual source (e.g. third party website), retrieved the search service domain 104, and/or correspond to a copy or variation of an original that resides on a third party site

As mentioned, different types of mechanisms may be used to communicate the search parameter 146 from the publisher domain 144 to the search domain 104. In one implementation, the component 130 is linked to the publisher interface 128 in the search domain 104. Upon trigger, the script submits identification information of the page to the publisher interface 128. The search service 102 uses the identification information to communicate back to the publisher (via the publisher interface 128) in form of a query to determine the parameter. The publisher 140 returns the parameter 146 to the publisher interface 128. The parameter 146 may include data that corresponds to or is based on the search result. According to one or more embodiments, the search parameter 146 includes context information (e.g. keywords that appear on the page of the script), or seed words (previously selected by the user). Upon receiving the search parameter 146, the search service 102 performs the search and returns the search results to the publisher. In one implementation, the search result is communicated as media object data 136, corresponding to one or more of (i) actual content, corresponding to a copy or variation (e.g. thumbnail) of individual media objects that are identified in the search result; (ii) links to the actual network location where the media objects identified by the search result reside; and (iii) other index information pertaining to the media objects (or their respective galleries) as identified in the search result. Upon receiving the media object data 136, the publisher 140 can process the search result (such as perform programmatic supervision, as described below). In one implementation, the publisher 140 retrieves media objects that comprise the gallery of the search result(s) and displays versions or portions on the page. The retrieval may be performed with respect to the actual source, or from index 110 or resources (e.g. database) of the search service.

In a variation, the programmatic component 130 is triggered to cause the publisher 140 to communicate with the publisher interface 128. In one embodiment, the publisher 140 supplies the script with identification information and other data for enabling the script to communicate the search parameter 146 to the publisher interface 128. The media object data 136 is returned from the search service 102 to the publisher 140. As another alternative, the script executes to trigger the publisher 140 to communicate directly with the publisher interface 128 and to receive the media object data. For example, the publisher 140 calls the publisher interface 128 to initiate a set of communications that results in the exchange of the search parameter 146 and the receipt of the media object data 136 (or other data contained in the search result 132).

In an embodiment, the media object data 136 may be rendered on the publisher resource 142 to supplement or enhance existing content. For example, in a web page (publisher resource) on travel, the publisher may supplement existing information about travel deals with images of exotic locations. The images of exotic locations may be derived from the search service, and may be presented in the form of a gallery or other presentation. The theme of the media objects as displayed may be based in part on the context of the page (e.g. if the page is about South American travel deals, the search parameter 146 may specify the content). In one alternative, the publisher may specify seed parameters, such as the name of islands or beaches, that are to serve as search terms and be communicated to the search service 102 as the parameter.

FIG. 2 illustrates logic that may be implemented with programmatic element 130, under an embodiment. Throughout the description of an embodiment of FIG. 2, reference is made to elements of FIG. 1 for purpose of context and illustration. According to an embodiment, when the programmatic component 130 is implemented as a script, the programmatic component performs one or more calls that implement the logic elements. In an embodiment, the logic elements include presentation/retrieval side elements, provided as (i) filter/control 210, (ii) formatter 214, and (iii) presentation component 216. The logic elements of the programmatic component 130 may also include a search parameter generator 220.

In an embodiment, the presentation side elements combine to process the media object data 136 (as returned with a part of the search result) and render media objects identified from the media object data 136. The filter/control 210 may serve to (i) filter select media object data from being displayed, and/or (ii) implement controls in how the media object data 136 is to be displayed. In one embodiment, the filter/control 210 may implement a set of rules to supervise the display of the media objects. The set of rules may be specified by the administrator of the publisher 140 when, for example, interacting with the publisher interface 128. The rules may filter search results based on, for example, an indication or determination as to the type of content that will be displayed with the media object data. Some publishers may have a class of content that would be inappropriate for display. A web page geared to young men, for example, would be adverse to displaying content from media objects that, for example, contain key words or a domain name (in the source link) that identifies alcohol, tobacco or retirement. Accordingly, the content/filter 210 may include exclusionary words or terms (or alternatively links), that if found associated with individual media object data, would cause that media object (or an associated gallery) to be dropped from use.

As an alternative or addition, the filter/control 210 may implement business rules. For example, a page that is sponsored or provided by a particular business enterprise may set the filter/control 210 to exclude content that identifies or originates from a competitor. Still further, filter/control rules may include some rules that allow for certain classes of media objects (as identified by information included in the search result) to be displayed in appropriate conditions. For example, the filter/control rules may specify that sponsored content (for which an author and/or publisher is to receive payment) may be limited. Other rules that the publisher may use to specify or exclude media objects include (i) data type and (ii) color/formatting. In one implementation, for example, the publisher may specify limited instances of video, or use of files with audio (as returned media object data 136). Color/formatting rules may coincide with an effort by the publisher to have the content from the service 102 appear similar in coloring or formatting to content existing on the publisher's page.

The formatter 214 may implement style/design rules in displaying content corresponding to the media object data on the publisher resource 142. The presentation component 216 may implement the rules to present, including formatting and determining when the media object data 136 is to be presented. The presentation component 216 can also include navigational components to enable the user to interact with presented galleries (including the individual media objects), as well as to click through or see media objects that comprise galleries. The navigational components can also enable the user to navigate to a host location of the media objects in the gallery. In the context of a commercial gallery, this can include a merchant that sells products displayed with the gallery.

As additions or alternatives, the component 130 can include sponsor/advertiser features to facilitate use of commercial content that is provided as or part of galleries. The components can monitor traffic generated through sponsored galleries, including click-throughs or viewership.

Functionality can also be included to enable individual media objects that comprise the gallery to be replaced by other media objects. For example, a media object of a non-sponsored gallery may be replaced by an advertisement, or media object that is sponsored. The selection of advertisement in this or any other context may be tailored to information determined about the context of the presentation, including a theme or content of other media objects in the gallery, a content appearing on the resource where the gallery is presented, and/or a demographic or geolocation associated with the web resource or galleries that are presented with the publisher.

Other functionality that can be provided with the component 130 includes functionality for enhancing selection of media objects, galleries or ad content. This functionality may, for example, execute on the web resource to rank (i) media objects in galleries, and/or (ii) placement of sponsored content (whether presented as part of a gallery or separate). Such functionality may be implemented to be “self-learning” though monitoring of user-interactions with sponsored or non-sponsored media objects.

The search parameter generator 220 operates to generate and communicate the search parameter 146 to the search service. The generator 220 may correspond to, or implement different processes for generating the search parameter 146. In one embodiment, the generator 146 uses contextual information 222 provided on the publisher resource 142 that includes the component 130. More specifically, the contextual information may include words (e.g. keywords), tags, or images that are displayed on the resource 142 and which may be analyzed to determine a context or relevant topic for content provided on the resource, particularly at a position that is proximate to where a presentation from the media object data 136 is to be provided.

In another embodiment, the generator 220 uses seed data 224. In some embodiments, the seed data 224 corresponds to terms and other parameter that the publisher administrator designates ahead of time. For example, the seed data can be determined from keywords appearing in content on the publisher's web resource, commercial content appearing with the publisher's web resource, intentional terms of interest (provided by the publisher or content suppliers on the publisher's site), geolocational information associated with the content or the IP address (e.g. URL), demographic information about the publisher or its audience or other user profiling information. In one embodiment, the publisher administrator may designate a set of parameters that are randomly, sequentially or otherwise triggered with events in the viewing/consumption of the resource.

Presentation

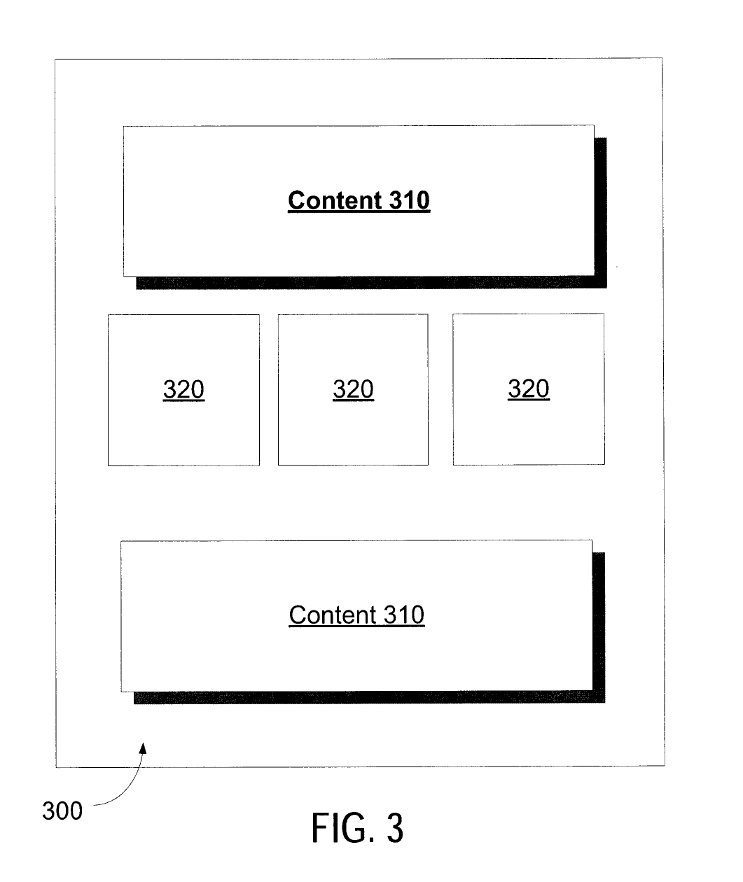

FIG. 3 illustrates an implementation in which a publisher resource is presented as a web page that is augmented with media object data, supplied from a search engine service, according to an embodiment. In FIG. 3, the publisher resource 142 corresponds to a web page. An administrator of the web page may insert a script corresponding to the programmatic component 130 into the source of the web page. As described with other embodiments, the inclusion of the script may trigger (on, for example, rendering the page to a viewer) the search service 102 to provide a search result of media object data 136. As mentioned with an embodiment of FIG. 2, the media object data 136 may be processed, by for example, filtering the media objects identified or provided with the media object data 136.

According to an embodiment, a web page 300 may include existing content 310. The media object data 136 may be used to present a gallery comprising media objects 320. In an embodiment, the media object gallery 320 may comprise and/or provide access to media objects that are united by theme or topic, so as to provide a gallery on the page 310. More than one gallery may be provided on a given page. Moreover, as an alternative, the media objects that are on display may be selected without the individual media object having previously been identified as being part of a gallery. Thus, the individual media objects may be eclectic, or alternatively, displayed as part of a gallery that is formed for the first time on the fly for the page 310.

The galleries that can be presented on page 310 include (i) non-sponsored galleries, (ii) sponsored galleries, (iii) coalesced or integrated galleries that include both sponsored and non-sponsored media objects (‘hybrids”). Still further, any of the galleries presented on the page 310 may be formulated from portions of two or more galleries (as originally identified or retrieved). Thus, for example, a web page 310 dedicated to tropical travel destinations can include a hybrid gallery of media objects from a non-sponsored collection (a user, or multiple users that each have galleries of a common location) and a sponsored collection (e.g. travel agent).

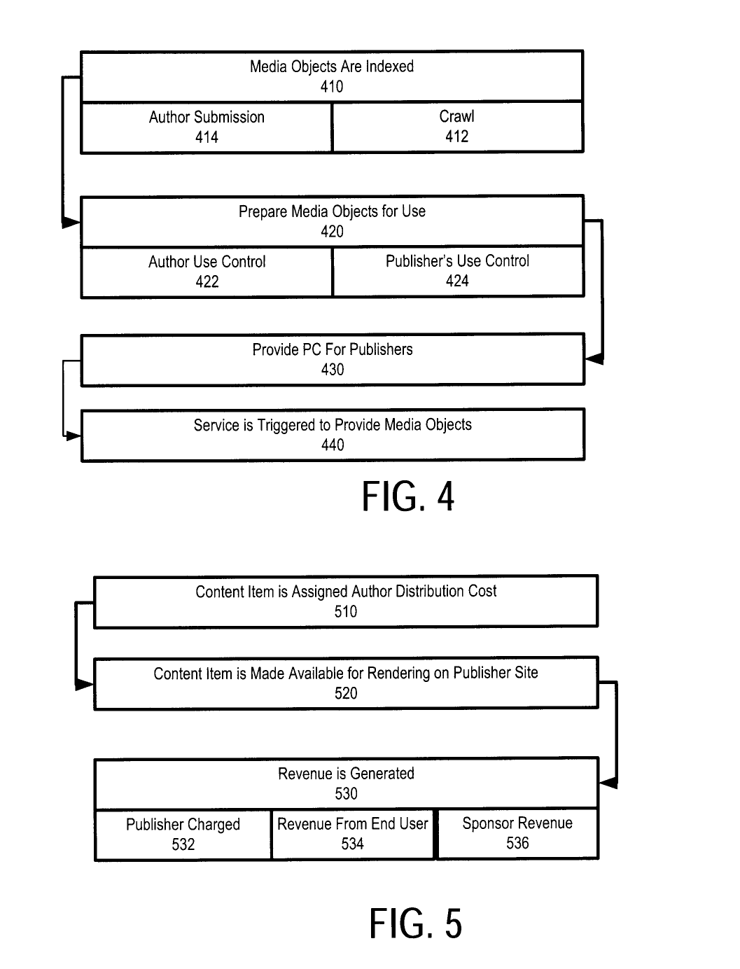

FIG. 4 illustrates a method for providing media objects that supplement existing content on a web page. A method such as described can be implemented using a system or service such as described with an embodiment of FIG. 1. Accordingly, reference is made to elements of FIG. 1 for purpose of illustrating suitable elements or components for performing a step or sub-step being described.

In step 410, media objects are indexed. The media objects may be derived from crawling web pages or resources (sub-step 412). As an alternative or addition, the media objects may be received as author submissions 119 (sub-step 414). As described with an embodiment of FIG. 1, author submissions 119 include author specified controls that regulate how the content items of the submission are used on a publisher's resource.

Step 420 provides that some or all of the media objects are prepared for use as part of service 102. The preparation of media objects can include associating controls with the individual media objects. As described above, sub-step 422 includes associating author controls with media objects submitted from an author. The controls can correspond to data or programmatic elements that are delivered or provided with media objects in order to enable the author or service 102 to maintain control over how the content is used. In particular, the author controls (i) include information that controls, when, how often or under what conditions the submitted media object can be displayed, and/or (ii) consideration for use of the media object. In the latter case, the author may charge a fee, for example, after each instance that the media object is displayed. As an addition or alternative, sub-step 424 provides that publisher or service controls with individual media objects. A publisher that subscribes to the service 102 (FIG. 1), for example, may specify filter controls with the service 102, to preclude the service from providing the publisher with media objects that are not suitable for the publisher. Such publisher control made at service 102 may serve to pre-screen media objects that are later sent to the publisher. Likewise, the service 102 may implement controls and associate control data with some media objects. Server control data may seek to identify, for example, subject matter that is obviously of a class that may not be suitable for all publishers. For example, the service 102 may tag media objects of an adult, violent or offensive nature.

Subsequent steps are performed once the media objects are indexed and prepared. In step 430, for example, the programmatic component 130 (FIG. 1) is configured and distributed to a publisher. In one embodiment, scripts are communicated to individual publishers to enable the publishers to access the service 102. According to some embodiments, a publisher interacts with the publisher interface 128 (provided by service 102) in order to specify parameters for enabling operation of the programmatic component on the publisher site. These parameters implement the functionality that the programmatic component performs when it is implemented, including (i) generating the selection or search parameter 146, and/or (ii) implementing the filtering, formatting, or presentation designations of the user. Additionally, the publisher may be able to interact with the publisher interface 128 in order to specify triggering parameters or conditions, such as the frequency in which selection/search parameter 146 is to be generated.

In some embodiments, the user has the ability to designate, for example, (a) seed parameters that are to be used as part of the selection/search criteria; and (b) whether the search/selection parameter is to be based on dynamically determined key words or other content or metadata appearing on the publisher resource. Once configured, the programmatic component 430 can include functionality for signaling triggers to the service 102, including triggers based on events that occur on the publisher site, including conditions or events that are pre-specified by the publisher. Examples of such events include, for example, a specific duration of time, or the rendering (or refresh of a page). When the programmatic component 430 is triggered, it specifies the selection or search criteria.

Step 440 provides that the service 102 is triggered to provide a publisher with media objects that comprise a gallery. The trigger is provided by the programmatic component 430 responding to an event or condition on the publisher site. The media objects 440 include sponsored objects (e.g. advertisements), non-commercial or sponsored objects (including those provided by authors seeking compensation) and combinations or hybrids. For example, some embodiments provide that service 102 delivers media objects to present one gallery on the publisher's site, when in fact the media objects originate from different galleries, authors or sources. Sponsored media galleries can correspond to sponsored media objects, links provided with media objects, and/or galleries that are published with additional advertiser content.

Revenue Sharing Embodiment

According to an embodiment, the media objects stored and distributed to publishers under embodiments such as described may be used to provide revenue to different parties, including to the author that submitted the media object. FIG. 5 illustrates a method for assigning and distributing revenue to media objects that are then made available to supplement existing content on a web page, according to an embodiment. In describing an embodiment of FIG. 5, reference may be made to elements of other figures for purpose of illustrating suitable elements for performing a step or sub-step being described.

In step 510, a media object is assigned distribution costs. In an embodiment, the distribution costs may be of at least two varieties. First, author distribution costs refer to costs that benefits authors for the publication of their media objects via service 102 (as described with, for example, an embodiment of FIG. 1). The author distribution cost may be specified by the author (i.e. as part of the author control, as described above) or by policy by, for example, the search service. Still further, the author distribution cost may be set by supply and demand (e.g. popular media objects may cost more).

Another variety of cost includes sponsorship costs. Sponsorship costs are costs that sponsors are charged by the service 102 for display of media objects that the sponsor supplies. Such sponsored content items may correspond to, for example, rich advertisement that a sponsor supplied to position media objects to supplement a website. For example, the sponsored content may include images or pictures that link to the sponsor's website.

In step 520, content items are made available for use to supplement publisher content, as described with, for example, embodiments of FIG. 1 or FIG. 2. At least some content items may be associated with costs (for author) or sponsor (from sponsor).

In step 530, revenue is calculated from the distribution of content items. The revenue generation may include (i) charging the publisher (532) for using authored content items, based on the author cost associated with the content item; (ii) paying the publisher for publishing sponsor content items, particularly those that are “clicked”; and/or, (iii) distributing at least some of the charges to the service 102.

It is contemplated for embodiments of the invention to extend to individual elements and concepts described herein, independently of other concepts, ideas or system, as well as for embodiments to include combinations of elements recited anywhere in this application. Although illustrative embodiments of the invention have been described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. Thus, the absence of describing combinations should not preclude the inventor from claiming rights to such combinations.

What is claimed is:

1. A method for publishing galleries, the method being implemented by one or more processors that perform steps comprising:
(a) providing a web resource on a network, the web resource being provided at a first location on the network;
(b) responsive to a terminal accessing the first location to render the web resource, signaling a search parameter to a search engine that operates at a second location on the network, the second location being maintained independent of the first location;
(c) receiving a search response from the search engine, the search engine including media object data that identifies one or more galleries of media objects; and
(d) using the media object data to include at least a portion of a gallery of media objects as part of the web resource that is rendered for the terminal.

2. The method of claim 1, wherein performing (b) includes generating the search parameter based on a content included as part of the web resource when the terminal accesses the first location.

3. The method of claim 2, wherein the content includes content submitted from other users for inclusion in the web resource.

4. The method of claim 1, wherein performing (b) includes using a seed value to signal the search parameter.

5. The method of claim 1, wherein the media object data includes image objects that comprise elements of the gallery of media objects.

6. The method of claim 1, wherein the media object data includes index identifiers to locate image objects that comprise elements of the gallery of media objects.

7. The method of claim 1, wherein performing (a) includes incorporating a script into the web resource that is triggerable to link the web resource with the search engine across the network.

8. The method of claim 1, further comprising filtering at least portions of the one or more galleries that are included as part of the search response.

9. The method of claim 8, wherein filtering at least portions of the one or more galleries includes excluding individual media objects or individual galleries of media objects based on one or more of (i) a key word, or (ii) a domain or network location of the individual media objects or galleries of media objects.

10. A computer-implemented method for publishing galleries, the method comprising:
(a) providing a programmatic element for inclusion with a web resource that is provided on a first location, wherein the programmatic element is configured to link the web resource to a search engine and to cause the web resource to signal a search parameter to the search engine;
(b) responsive to the programmatic element being triggered by an instance of a terminal accessing the first location to render the web resource, using a search parameter communicated from either the web resource or a source of the web resource, to perform a search of a collection of galleries in order to identify one or more galleries of media objects that satisfy a criteria identified from the search parameter;
(c) signaling the search result to the web resource or its source, in order to cause at least a portion of the gallery of media objects identified by the search result to be included in the rendering of the web resource on the terminal.

11. The method of claim 10, wherein performing (a) includes generating a script for inclusion with the web resource when the web resource is requested by any terminal that accesses the first location.

12. The method of claim 10, further comprising generating the search parameter from execution of the script when the web resource is requested by a given terminal.

13. The method of claim 12, wherein generating the search parameter includes generating a term or string of characters based at least in part on other text provided with the web resource at an instance in which the given terminal requests the web resource.

14. The method of claim 12, wherein generating the search parameter includes generating a term or string of characters based in part on user-provided comments that are hosted on the web resource at the instance.

15. The method of claim 12, wherein generating the search parameter includes identifying the search parameter using a seed value that is associated with the web resource, the seed value identifying one or more terms or character strings.

16. A computer-implemented method for publishing content, the method comprising:
(a) providing a programmatic element for inclusion with a web resource that is provided on a first network location, wherein the programmatic element is configured to (i) link the web resource to a search engine and (ii) to cause the web resource to signal a search parameter to the search engine;
(b) enabling a publisher of the web resource to associate or provide control information for use with the programmatic element;
(c) responsive to the programmatic element being triggered by an instance of a terminal accessing the first location to render the web resource, signaling a search parameter generated in part from execution of the programmatic element to the search engine;
wherein the search engine is located at a second network location that is on a domain that is different than a domain of the first network location;
(d) receiving a search result from the search engine based on the search parameter; and
(e) programmatically and automatically excluding at least one or more items in the search result based on control information specified by the publisher of the web resource.

17. The method of claim 16, wherein performing (e) includes excluding one or more items of the search result based on a keyword included or associated with the one or more items.

18. The method of claim 16, wherein performing (e) includes excluding one or more items of the search result based on a domain or network address associated with the one or more items.

19. The method of claim 16, wherein performing (c) includes receiving one or more galleries of media objects.

20. A system for publishing galleries, the system comprising:
a search component that is configured to perform a search for galleries of media objects, wherein the search component performs the search to identify individual galleries of media objects that satisfy a criteria;
a programmatic element that is configured to generate or specify a search criteria based on one or more instances of activity that occur on or with the web resource, the programmatic element causing the search criteria to be communicated to the search component;
a publisher distribution component that interfaces with either a web resource or a source of the web resource, in order to (i) receive the search criteria and interface with the search component to enable the search component to use the search criteria to perform a search for one or more galleries of media objects that satisfy the criteria, (ii) return a search result to the web resource or the source of the web resource, the search result identifying or including one or more galleries of media objects that satisfy the search criteria, so that the web resource renders at least a portion of at least one gallery as part of its content.
